(19) United States
(12) Patent Application Publication
(10) Pub. No.: US 2006/0131105 A1
(43) Pub. Date: Jun. 22, 2006

(54) Tree stand safety harness

(76) Inventor: Ken Brown JR., Downingtown, PA (US)

Correspondence Address: The Law Office of Anthony R. Carlis, Suite 1D, 110 Hopewell Road, Downigtown, PA, 19335, US

(21) Appl. No.: 11/311,297

(22) Filed: Dec. 19, 2005

Related U.S. Application Data
(60) Provisional application No. 60/636,909, filed on Dec. 18, 2004.

(51) Int. Cl. A62B 35/00

(52) U.S. Cl. 182/3

(57) ABSTRACT

The present invention is directed to a tree stand in which the user may quickly and quietly unhook his safety harness by merely standing up. The hunter is safe as long as he stays in the sitting position and therefore protected from inadvertently falling out of the tree stand if he falls asleep or becomes ill while in the stand.

### CROSS REFERENCE TO RELATED APPLICATION

This application claims priority from U.S. provisional application no. 60/636,909 which was filed on Dec. 17, 2004, which is incorporated by reference as if fully set forth.

### BACKGROUND OF THE INVENTION

The present invention relates generally to hunter tree stands adapted to be attached to a selected tree with which a hunter may elevate and support himself for subsequent hunting. A tree stand normally elevates a hunter in a position readily facilitating the observation of and subsequent taking of game animals.

As will be readily be appreciated by skilled hunters, tree stands provide a number of practical advantages. Skilled hunters recognize the desirability of assuming a relatively camouflaged position as the approach of a game animal is awaited. Since the hunter must often wait for relatively long periods of time until a suitable game animal approaches, he must deploy himself in a comfortable position where his relative safety is assured and his subsequent ease in shooting is guaranteed.

Problems can occur if the hunter “drowses off” and/or becomes disorientated, he may accidentally fall out of the tree if not securely attached the tree or the tree stand. Therefore the hunter will attach himself to the tree or to the tree stand. With the current state of tree stands, when the hunter does detect game approaching, he must unhook his safety harness to take a shot. Not only does this take time, it can produce noise and chase the game away. Therefore, what is needed is a safety harness which automatically releases the hunter when he stands up, but does not release the hunter if he inadvertently slumps over if he does fall asleep or becomes ill. The hunter will is therefore protected from falling out of the tree or tree stand.

### SUMMARY

The present invention is directed to a tree stand in which the user may quickly and quietly unhook his safety harness by merely standing up. The hunter is safe as long as he stays in the sitting position and therefore protected from inadvertently falling out of the tree stand if he falls asleep or becomes ill while in the stand.

### DETAILED DESCRIPTION OF THE PREFERRED EMBODIMENTS

In a first embodiment a tree stand safety harness is disclosed which protects a hunter from inadvertently from falling out of a tree stand if he falls asleep or becomes ill. The hunter wears a safety harness which attached to the tree stand when the hunter is sitting down. When the hunter stands up, he becomes unattached and unencumbered allowing him to take a clan shot at his game. The hunter will not have reach around to unhook himself from the stand which take time and may cause noise which will chase away the game.

In a second embodiment the present invention can be used in a tree with out a tree stand.

What is claimed is:

1. A tree stand safety harness for a tree stand for use in a tree, wherein a user becomes unattached from the tree stand by standing, thereby protecting the user from falling out of said tree.

2. The tree stand safety harness of claim 1, wherein the user is released by intentionally changing his position.
